(19) United States
(12) Patent Application Publication
(10) Pub. No.: US 2026/0252192 A1
(43) Pub. Date: Aug. 27, 2026

(54) Touch Detection Circuit and Touch Display Device

(71) Applicant: LG Display Co., Ltd., Seoul (KR)

(72) Inventors: Jongsung Kim, Paju-si (KR); NamYong Gong, Paju-si (KR); HoonBae Kim, Paju-si (KR); Sung-Jin Kang, Paju-si (KR); Jeonghoon Lee, Paju-si (KR)

(21) Appl. No.: 19/443,870

(22) Filed: Jan. 8, 2026

(30) Foreign Application Priority Data
Feb. 27, 2025 (KR) 10-2025-0026097

(51) Int. Cl. G06F 3/041; G06F 3/044

(52) U.S. Cl. CPC G06F 3/04166; G06F 3/0446; G06F 3/0443; G06F 3/0445; G06F 2203/04108; G06F 2203/04111

(57) ABSTRACT

Embodiments of the present disclosure are related to a touch display device. If a contact touch is detected during a first frame in which the touch display device operates in a non-contact touch mode during a first touch period and a second touch period, the touch display device may operate in a contact touch mode during a touch period in a second frame subsequent to the first frame, thereby improving touch performance.

### CROSS REFERENCE TO RELATED APPLICATION

The present application claims priority to Republic of Korea Patent Application No. 10-2025-0026097, filed on February 27, 2025, which is hereby incorporated by reference in its entirety.

### TECHNICAL FIELD

Embodiments of the present disclosure relate to a touch detection circuit and a touch display device including the touch detection circuit.

### BACKGROUND

Recently, there has been developed a touch display device capable of detecting touch by a user's finger or pen and providing touch-based input processing functions.

In order for this touch display device to provide more various application functions, there is a demand for various forms of touch sensing.

For example, a touch display device is required to have the function to detect not only contact touch at which the user touches the screen, but also non-contact touch in which the user does not touch the screen.

The description provided in the discussion of the related art section should not be assumed to be prior art merely because it is mentioned in or associated with that section. The discussion of the related art section may include information that describes one or more aspects of the subject technology, and the description in this section does not limit the disclosure.

### SUMMARY

Embodiments of the present disclosure may provide a touch detection circuit and a touch display device capable of more efficiently detecting a contact touch and a non-contact touch based on a dual touch mode.

Embodiments of the present disclosure may provide a touch detection circuit and a touch display device capable of increasing a touch report rate or increasing the detection time of a contact touch by applying the optimal contact touch mode when detecting a contact touch in a dual touch mode.

Embodiments of the present disclosure may provide a touch detection circuit and a touch display device capable of improving touch performance by applying the optimal contact touch mode when detecting a contact touch in a dual touch mode.

Embodiments of the present disclosure may provide a touch detection circuit and a touch display device capable of reducing unnecessary touch detection time by applying touch sleep mode, thereby operating at low power by minimizing or at least reducing current consumption.

The objects of the embodiments of the present disclosure are not limited to the objects described in this disclosure, and other objects will be clearly understood by those skilled in the art from the description below.

A touch display device according to embodiments of the present disclosure may include a display panel on which a plurality of sub-pixels are arranged, a display driving circuit for driving the plurality of sub-pixels, and a touch detection circuit for detecting at least one touch operation of a contact touch and a non-contact touch through a touch sensor arranged on the display panel.

The touch detection circuit may operate in a non-contact touch mode during a first touch period and a second touch period within a first frame among a plurality of frames each including at least one touch period and a display period, and, if the contact touch is detected during at least one touch period among the first touch period within the first frame and the second touch period within the first frame, may operate in a contact touch mode during a touch period within a second frame subsequent to the first frame.

A touch detection circuit according to embodiments of the present disclosure may include a touch controller that supplies a mode control signal for controlling a touch mode for detecting at least one touch operation among a contact touch and a non-contact touch, and a touch synchronization signal corresponding to the mode control signal; and a touch driving circuit that supplies a touch driving signal corresponding to the mode control signal and the touch synchronization signal to a touch sensor arranged on a display panel.

The touch controller may supply the touch synchronization signal defining a first touch period and a second touch period in a first frame among a plurality of frames each including at least one touch period and a display period, and the mode control signal controlling to operate in a non-contact touch mode during the first touch period within the first frame and the second touch period within the first frame.

If the contact touch is detected during the first frame, the touch controller may supply one touch synchronization signal among a first touch synchronization signal defining a first touch period and a second touch period in a second frame following the first frame, and a second touch synchronization signal defining a single touch period in the second frame, and the mode control signal controlling to operate in a contact touch mode during at least one touch period within the one touch synchronization signal.

A touch display device according to one or more other embodiments of the present disclosure includes a display panel, a touch sensor on the display panel, the touch sensor including a plurality of touch electrodes, and a touch driving circuit configured to detect a touch operation through the touch sensor, the plurality of touch electrodes electrically connected to the touch driving circuit via a plurality of touch lines. The touch driving circuit includes a sensing unit block for detecting a touch sensing signal from the touch sensor indicative of the touch operation, the sensing unit block including a plurality of sensing units, a plurality of first switches connected to the plurality of touch lines, each of the plurality of first switches controlling electrical connection between one of the plurality of touch electrodes and a corresponding one of the plurality of sensing units, and a plurality of second switches, each switch of the plurality of second switches connected between corresponding two touch lines of the plurality of touch lines and controlling electrical connection between corresponding two touch electrodes of the plurality of touch electrodes.

According to embodiments of the present disclosure, it is possible to provide a touch detection circuit and a touch display device capable of more efficiently detecting a contact touch and a non-contact touch based on a dual touch mode.

According to embodiments of the present disclosure, it is possible to provide a touch detection circuit and a touch display device capable of increasing a touch report rate or increasing the detection time of a contact touch by applying the optimal contact touch mode when detecting a contact touch in a dual touch mode.

According to embodiments of the present disclosure, it is possible to provide a touch detection circuit and a touch display device capable of improving touch performance by applying the optimal contact touch mode when detecting a contact touch in a dual touch mode.

According to embodiments of the present disclosure, it is possible to provide a touch detection circuit and a touch display device capable of reducing unnecessary touch detection time by applying a touch sleep mode, thereby operating at low power by minimizing or at least reducing current consumption.

The effects of the embodiments of the present disclosure are not limited to the effects described as above, and other effects will be clearly understood by those skilled in the art from the claims.

It is to be understood that both the foregoing general description and the following detailed description are exemplary and explanatory and are intended to provide further explanation of the inventive concepts as claimed.

### BRIEF DESCRIPTION OF THE DRAWINGS

The present disclosure will be more fully understood from the detailed description and accompanying drawings provided below, which are provided for illustration purposes only and are not intended to limit the present disclosure.

FIG. 1 is a diagram for explaining a touch display device according to one or more embodiments of the present disclosure.

FIGS. 2 and 3 are diagrams for further explaining a touch sensor according to one or more embodiments of the present disclosure.

FIG. 4 is a diagram for further explaining an implementation example of a touch driving circuit according to one or more embodiments of the present disclosure.

FIG. 5 is a diagram for further explaining a touch detection circuit according to one or more embodiments of the present disclosure.

FIGS. 6 to 8 are diagrams for further explaining a contact touch mode and a non-contact touch mode according to one or more embodiments of the present disclosure.

FIGS. 9 to 12 are diagrams for further explaining the operation process of a touch detection circuit according to one or more embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present invention rather unclear. The terms such as “including”, “having”, “comprising”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present invention. Each of these terms is not used to define essence, order, sequence, or number of elements etc., but is used merely to distinguish the corresponding element from other elements.

When it is mentioned that a first element "is connected or coupled to", “contacts or overlaps” etc. a second element, it should be interpreted that, not only can the first element “be directly connected or coupled to” or “directly contact or overlap” the second element, but a third element can also be "interposed" between the first and second elements, or the first and second elements can "be connected or coupled to", “contact or overlap”, etc. each other via a fourth element. Here, the second element may be included in at least one of two or more elements that "are connected or coupled to", “contact or overlap”, etc. each other.

When time relative terms, such as "after," "subsequent to," "next," "before," and the like, are used to describe processes or operations of elements or configurations, or flows or steps in operating, processing, manufacturing methods, these terms may be used to describe non-consecutive or non-sequential processes or operations unless the term "directly" or "immediately" is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”

Any implementation described herein as an “example” is not necessarily to be construed as preferred or advantageous over other implementations.

In the description of the various embodiments of the present disclosure, where positional relationships are described, for example, when a position relation between two parts is described as, for example, “on,” “over,” “under,” and “next,” or the like, one or more other parts may be located between the two parts unless a more limiting term, such as “just” or “direct(ly)” is used. For example, where an element or layer is disposed “on” another element or layer, a third layer or element may be interposed therebetween.

The expression of a first element, a second elements “and/or” a third element should be understood as one of the first, second and third elements or as any or all combinations of the first, second and third elements. By way of example, A, B and/or C can refer to only A; only B; only C; any or some combination of A, B, and C; or all of A, B, and C.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood to one of ordinary skill in the art.

Features of various embodiments of the present disclosure may be partially or overall coupled to or combined with each other, and may be variously inter-operated with each other and driven technically as those skilled in the art can sufficiently understand. Embodiments of the present disclosure may be carried out independently from each other, or may be carried out together in co-dependent relationship.

Hereinafter, various embodiments of the present disclosure are described in detail with reference to the accompanying drawings.

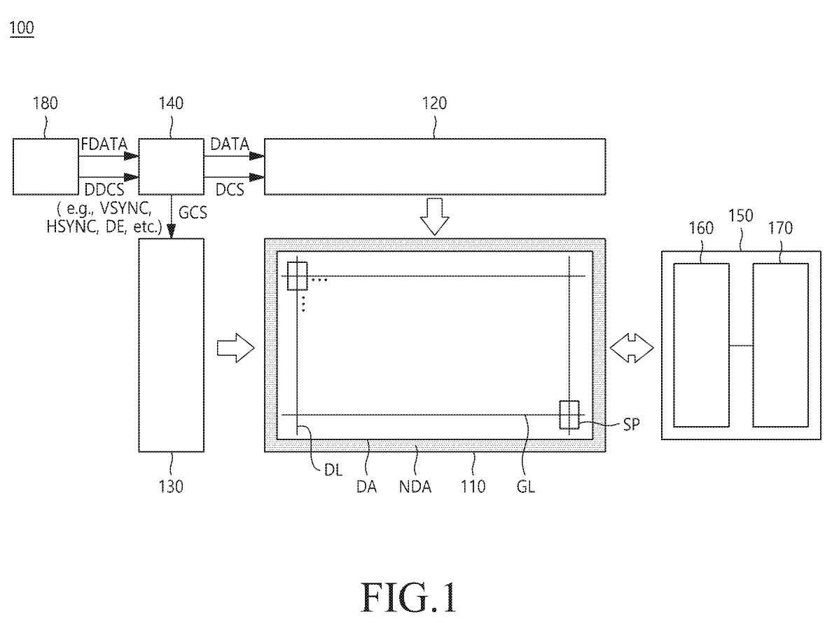

FIG. 1 is a diagram for explaining a touch display device according to one or more embodiments of the present disclosure.

Referring to FIG. 1, a touch display device 100 according to one or more embodiments of the present disclosure may include, as components for displaying images, a display panel 110 and a display driving circuit.

The display driving circuit may be a circuit for driving a display panel 110, and may include a data driving circuit 120 and a gate driving circuit 130, and may further include a display controller 140.

The display panel 110 may include a display area DA where an image is displayed and a non-display area NDA where an image is not displayed. The non-display area NDA may be an outer area of the display area DA, and may also be referred to as a bezel area. All or part of the non-display area NDA may be an area visible from the front of the touch display device 100, or may be an area which is bent and not visible from the front of the touch display device 100.

The display panel 110 may include a plurality of sub-pixels SP and various types of signal lines for driving the plurality of sub-pixels SP.

The various types of signal lines may include a plurality of data lines DL which transmit data signals (also referred to as data voltages or image signals) and a plurality of gate lines GL which transmit gate signals (also referred to as scanning signals).

A plurality of data lines DL and a plurality of gate lines GL may intersect each other. Each of the plurality of gate lines GL may be arranged while extending in a first direction (e.g., row direction). Each of the plurality of data lines DL may be arranged while extending in a second direction (e.g., column direction).

The data driving circuit 120 is a circuit for driving a plurality of data lines DL, and may output the data signal to the plurality of data lines DL. The gate driving circuit 130 is a circuit for driving a plurality of gate lines GL, and may output the gate signal to the plurality of gate lines GL.

The display controller 140 may receive input data FDATA and a display driving control signal DDCS from a host system 180. For example, the display driving control signal DDCS may include a vertical synchronization signal VSYNC, a horizontal synchronization signal HSYNC, and a data enable signal DE.

The display controller 140 may supply image data DATA to the data driving circuit 120 based on the input data FDATA. In addition, the display controller 140 may be a device for controlling the data driving circuit 120 and the gate driving circuit 130, and may control the driving timing for a plurality of data lines DL and the driving timing for a plurality of gate lines GL.

The display controller 140 may supply a data driving control signal DCS to the data driving circuit 120 to control the data driving circuit 120, and may supply a gate driving control signal GCS to the gate driving circuit 130 to control the gate driving circuit 130.

The data driving circuit 120 may supply a data signal to a plurality of data lines DL according to the driving timing control of the display controller 140. The data driving circuit 120 may receive image data DATA in digital form from the display controller 140, convert the received image data DATA into data signals in analog form, and output the converted image data to a plurality of data lines DL.

The gate driving circuit 130 may supply a gate signal to a plurality of gate lines GL according to the timing control of the display controller 140. The gate driving circuit 130 may receive a first gate voltage corresponding to a turn-on level voltage and a second gate voltage corresponding to a turn-off level voltage together with various gate driving control signals GCS, generate the gate signal, and supply the generated gate signal to a plurality of gate lines GL. For example, the first gate voltage may be a voltage higher than the second gate voltage. Alternatively, the second gate voltage may be a voltage higher than the first gate voltage.

For example, the data driving circuit 120 may be connected to the display panel 110 by a tape automated bonding (TAB) method, or may be connected to a bonding pad of the display panel 110 by a chip-on-glass (COG) or chip-on-panel (COP) method, or may be connected to the display panel 110 by being implemented as a chip-on-film (COF) method.

For example, the gate driving circuit 130 may be connected to the display panel 110 using a tape automated bonding (TAB) method, or may be connected to a bonding pad of the display panel 110 using a chip-on-glass (COG) or chip-on-panel (COP) method, or may be connected to the display panel 110 according to a chip-on-film (COF) method. Alternatively, the gate driving circuit 130 may be a gate- in-panel (GIP) type, and may be formed in the non-display area NDA of the display panel 110. The gate driving circuit 130 may be disposed on or connected to the substrate SUB. That is, if the gate driving circuit 130 is of the GIP type, it may be disposed in the non-display area NDA of the substrate SUB. The gate driving circuit 130 may be connected to the substrate SUB in the case of a chip-on-glass (COG) type, chip-on-film (COF) type, etc.

Meanwhile, at least one of the data driving circuit 120 and the gate driving circuit 130 may be disposed in the display area DA. For example, at least one of the data driving circuit 120 and the gate driving circuit 130 may be disposed not to overlap with the sub-pixels SP, or may be disposed to partially or entirely overlap with the sub-pixels SP.

Depending on the driving method, panel design method, and panel shape, each of the data driving circuit 120 and the gate driving circuit 130 may be connected to one side of the display panel 110, may be connected to one side and the other side of the display panel 110, or may be connected along the side of the display panel 110.

The display controller 140 may be implemented as a separate component from the data driving circuit 120, or may be implemented as an integrated circuit integrated with the data driving circuit 120.

The display controller 140 may be a timing controller used in typical display technology, or may be a control device capable of further performing other control functions including a timing controller, or may be a control device different from the timing controller, or may be a control device other than a timing controller, or may be a circuit within the control device.

The display controller 140 may be mounted on a printed circuit board or a flexible printed circuit, and may be electrically connected to the data driving circuit 120 and the gate driving circuit 130 through the printed circuit board or the flexible printed circuit.

Meanwhile, the touch display device 100 according to one or more embodiments of the present disclosure may include a touch sensor and a touch detection circuit 150 to provide the touch detection function in addition to an image display function.

The touch detection circuit 150 may detect at least one touch operation or touch action among a contact touch or a non-contact touch through a touch sensor disposed on the display panel 110.

For example, the contact touch may refer to a touch action in which a user directly contacts the screen with a touch pointer of a touch object (e.g., a finger, a pen, etc.), and the non-contact touch may refer to an action in which a user indicates a point on the screen with a touch pointer without directly contacting the screen (i.e., a hover action) or moves a touch pointer (i.e., a gesture action).

The touch detection circuit 150 may include a touch driving circuit 160 for driving and sensing the touch sensor to generate and output touch sensing data, and a touch controller 170 for detecting touch occurrence or detecting a touch location using the touch sensing data.

The touch sensor may include a plurality of touch electrodes. The plurality of touch electrodes may be electrically connected to the touch driving circuit 160 through a plurality of touch lines.

The touch driving circuit 160 and the touch controller 170 included in the touch detection circuit 150 may be implemented as separate devices or as one device. In addition, the touch driving circuit 160 and the data driving circuit 120 may be implemented as separate devices or as one device.

For example, the touch driving circuit 160 may be implemented as a readout integrated circuit (ROIC). Alternatively, the touch driving circuit 160 and the data driving circuit 120 may be integrated and implemented as a source and readout integrated circuit (SRIC). The touch controller 170 may be implemented as a micro control unit (MCU).

The touch display device 100 according to one or more embodiments of the present disclosure may be a display device whose display panel cannot emit light on its own, such as a liquid crystal display device, or may be a self-luminous display device whose display panel can emit light by itself. For example, the touch display device 100 according to one or more embodiments of the present disclosure may be one of an organic light-emitting diode (OLED) display device, a quantum dot display device, a light-emitting diode (LED) display device, etc.

The touch display device 100 according to one or more embodiments of the present disclosure may be a mobile terminal such as a smart phone or tablet, or a monitor or television (TV) of various sizes, and is not limited thereto, and may be a display of various types and sizes capable of displaying information or images.

Alternatively, the touch display device 100 according to one or more embodiments of the present disclosure may be a wearable device that can be worn on the human body, such as a smart watch.

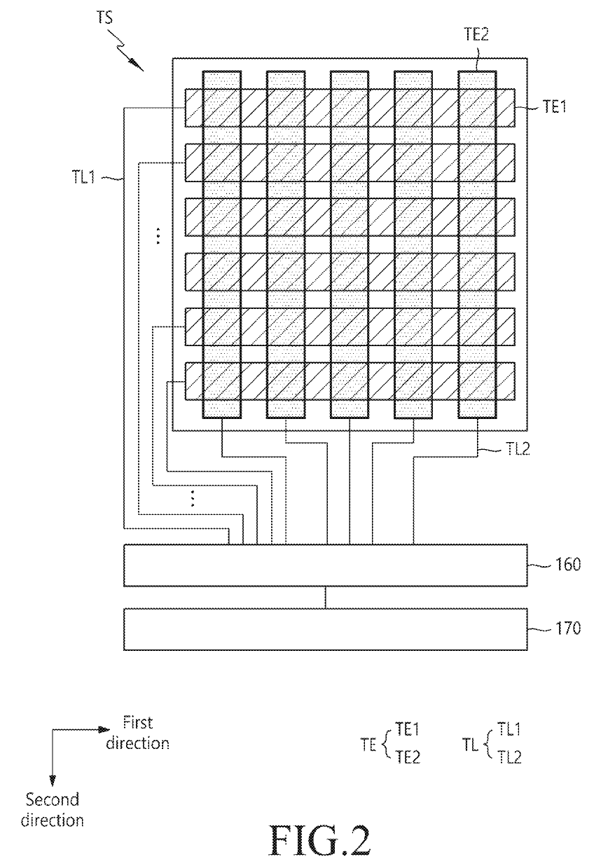

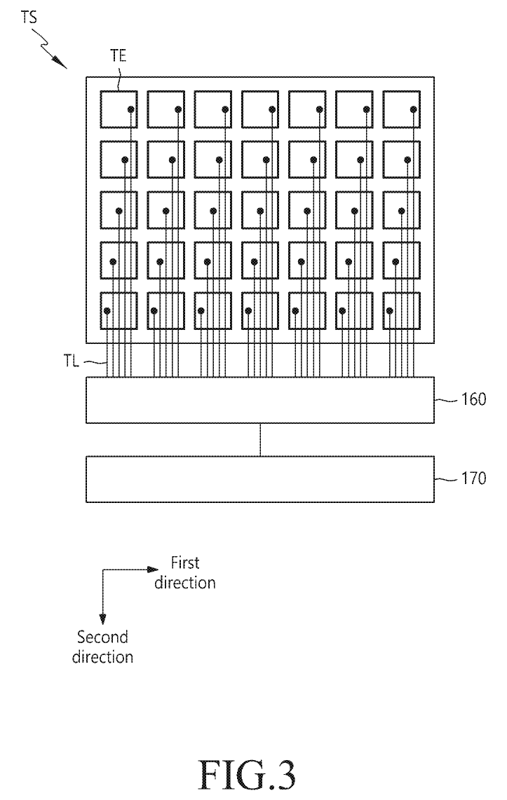

FIGS. 2 and 3 are diagrams for further explaining a touch sensor TS according to one or more embodiments of the present disclosure.

Specifically, FIG. 2 illustrates one embodiment of a touch sensor TS structure according to embodiments of the present disclosure, and FIG. 3 illustrates another embodiment of a touch sensor TS structure according to embodiments of the present disclosure.

Referring to FIG. 2, the touch driving circuit 160 may detect or sense the touch sensor TS and generate touch sensing data as a detection result, and provide the touch sensing data to the touch controller 170.

According to the example of FIG. 2, the touch sensor TS may include a plurality of touch electrodes TE, and the plurality of touch electrodes TE may be electrically connected to the touch driving circuit 160 through a plurality of touch lines TL.

Referring to FIG. 2, the plurality of touch electrodes TE may include a plurality of first touch electrodes TE1 and a plurality of second touch electrodes TE2. For example, the plurality of first touch electrodes TE1 and the plurality of second touch electrodes TE2 may intersect each other. Each of the plurality of first touch electrodes TE1 may extend in a first direction, and each of the plurality of second touch electrodes TE2 may extend in a second direction intersecting the first direction. Accordingly, a portion of each of the plurality of first touch electrodes TE1 may overlap with the plurality of second touch electrodes TE2.

Referring to FIG. 2, the plurality of first touch electrodes TE1 may be electrically connected to the touch driving circuit 160 through a plurality of first touch lines TL1, and the plurality of second touch electrodes TE2 may be electrically connected to the touch driving circuit 160 through a plurality of second touch lines TL2.

The touch sensor TS may be implemented as a touch panel, and may be separately located outside the display panel 110 or may be located inside the display panel 110.

An external touch sensor TS located outside the display panel 110 may be manufactured separately from the display panel 110 and then combined with the display panel 110 during the assembly process. The external touch sensor TS may be implemented as a touch panel including a substrate and multiple touch electrodes on the substrate.

An embedded touch sensor TS located inside the display panel 110 may be formed together with electrodes and wirings related to display operation during the manufacturing process of the display panel 110. For convenience of explanation, it is assumed below that the touch sensor TS is an embedded touch sensor TS located inside the display panel 110.

The touch driving circuit 160 may supply a touch driving signal to at least one of the plurality of touch electrodes TE included in the touch sensor TS and detect or sense at least one of the plurality of touch electrodes to generate touch sensing data. Here, the touch driving signal may be a signal with a variable voltage level.

The touch detection circuit 150 may detect touch using a mutual-capacitance detection method or a self-capacitance detection method.

In the case that the touch detection circuit 150 performs touch detection using a mutual-capacitance detection method, the touch detection circuit 150 may perform touch detection based on the capacitance between the first touch electrode TE1 and the second touch electrode TE2.

According to the mutual-capacitance detection method, the plurality of touch electrodes TE may be divided into driving touch electrodes (also referred to as transmitting touch electrodes) and sensing touch electrodes (also referred to as receiving touch electrodes). The touch driving circuit 160 may drive the driving touch electrodes and sense the sensing touch electrodes. Hereinafter, mutual-capacitance sensing may also be referred to as “mutual sensing.”

For example, in mutual sensing, the plurality of first touch electrodes TE1 may be driving touch electrodes (or transmitting touch electrodes) and the plurality of second touch electrodes TE2 may be sensing touch electrodes (or receiving touch electrodes). As another example, in mutual sensing, the plurality of first touch electrodes TE1 may be sensing touch electrodes (or receiving touch electrodes) and the plurality of second touch electrodes TE2 may be driving touch electrodes (or transmitting touch electrodes). In the following, for convenience of explanation, it is exemplified a case in which the plurality of first touch electrodes TE1 are driving touch electrodes (or transmitting touch electrodes) and the plurality of second touch electrodes TE2 are sensing touch electrodes (or receiving touch electrodes).

In the case that the touch detection circuit 150 performs touch detection using a self-capacitance detection method, the touch detection circuit 150 may perform touch detection based on the capacitance between each touch electrode TE and a touch object (e.g., a finger, a pen, etc.).

According to the self-capacitance detection method, each of the plurality of touch electrodes TE may serve as both a driving touch electrode and a sensing touch electrode. The touch driving circuit 160 may drive all or part of the plurality of touch electrodes TE and detect all or part of the plurality of touch electrodes TE. Hereinafter, self-capacitance detection may also be referred to as "self-sensing."

For example, during self-sensing, the touch driving circuit 160 may supply a touch driving signal to at least one of the plurality of first touch electrodes TE1 and detect at least one first touch electrode TE1 to which the touch driving signal has been supplied. The touch driving circuit 160 may supply a touch driving signal to at least one of the plurality of second touch electrodes TE2 and may detect at least one second touch electrode TE2 to which the touch driving signal has been supplied.

Referring to FIG. 2, one first touch line TL1 may be connected to each of the plurality of first touch electrodes TE1. Alternatively, two first touch lines TL1 may be connected to each of the plurality of first touch electrodes TE1. In this case, a first touch line TL1 may be connected to each of one end and the other end of one first touch electrode TE1.

One second touch line TL2 may be connected to each of the plurality of second touch electrodes TE2. Alternatively, two second touch lines TL2 may be connected to each of the plurality of second touch electrodes TE2. In this case, a second touch line TL2 may be connected to one end and the other end of a second touch electrode TE2.

For example, each of the plurality of first touch electrodes TE1 and the plurality of second touch electrodes TE2 may be bar-shaped.

As another example, each of the plurality of first touch electrodes TE1 and the plurality of second touch electrodes TE2 may be configured as a plurality of sub-electrodes electrically connected to each other by bridge electrodes.

As another example, each of the plurality of first touch electrodes TE1 may be formed integrally, and each of the plurality of second touch electrodes TE2 may be configured as a plurality of sub-electrodes electrically connected to each other by bridge electrodes.

As another example, each of the plurality of second touch electrodes TE2 may be formed integrally, and each of the plurality of first touch electrodes TE1 may be configured as a plurality of sub-electrodes electrically connected to each other by bridge electrodes.

For example, a plurality of first touch electrodes TE1 may be disposed within a first sensor metal layer, and a plurality of second touch electrodes TE2 may be disposed within a second sensor metal layer. Here, a sensor interlayer insulating film may be disposed between the first sensor metal layer and the second sensor metal layer.

As another example, if each of the plurality of first touch electrodes TE1 is formed integrally, and each of the plurality of second touch electrodes TE2 is composed of a plurality of sub-electrodes electrically connected to each other by bridge electrodes, the plurality of first touch electrodes TE1 and the plurality of sub-electrodes may be disposed within the sensor metal layer, and the bridge electrodes electrically connecting the plurality of sub-electrodes may be disposed within the bridge metal layer. Here, a sensor interlayer insulating film may be disposed between the sensor metal layer and the bridge metal layer.

As another example, if each of the plurality of second touch electrodes TE2 is formed integrally, and each of the plurality of first touch electrodes TE1 is composed of a plurality of sub-electrodes electrically connected to each other by bridge electrodes, the plurality of second touch electrodes TE2 and the plurality of sub-electrodes may be disposed within a sensor metal layer, and the bridge electrodes electrically connecting the plurality of sub-electrodes may be disposed within a bridge metal layer. Here, a sensor interlayer insulating film may be disposed between the sensor metal layer and the bridge metal layer.

Referring to FIG. 2 , in the touch display device 100 according to one or more embodiments of the present disclosure, each of the plurality of touch electrodes TE may correspond to the size of two or more sub-pixels SP.

For example, each of the plurality of touch electrodes TE may be a mesh-type electrode having two or more openings and may overlap with two or more sub-pixels SP. The two or more openings may overlap with the light-emission areas of two or more sub-pixels SP. That is, light emitted from two or more sub-pixels SP can be emitted toward the front of the display panel 110 through two or more openings.

Referring to FIG. 3, another touch sensor structure of a touch display device 100 according to one or more embodiments of the present disclosure may include a plurality of non-overlapping touch electrodes TE that do not overlap with each other.

Referring to FIG. 3, another touch sensor structure of a touch display device 100 according to one or more embodiments of the present disclosure may further include a plurality of touch lines TL for electrically connecting the plurality of touch electrodes TE to the touch driving circuit 160.

Referring to FIG. 3, each of the plurality of touch lines TL may overlap with at least one touch electrode TE. For example, one touch line TL may overlap with an electrically connected touch electrode TE and may also overlap with at least one non-electrically connected touch electrode TE.

Referring to FIG. 3, in the touch display device 100 according to one or more embodiments of the present disclosure, each of the plurality of touch electrodes TE may correspond to the size of at least one sub-pixel SP.

For example, each of the plurality of touch electrodes TE may be a mesh-type electrode having at least one opening and may overlap with at least one sub-pixel SP. At least one opening may overlap with the light-emission area of at least one sub-pixel SP. That is, light emitted from at least one sub-pixel SP may be emitted toward the front of the display panel 110 through at least one opening.

Referring to FIG. 3, during self-sensing, the touch driving circuit 160 may supply a touch driving signal to at least one of the plurality of touch electrodes TE and detect at least one touch electrode TE to which the touch driving signal has been supplied.

Hereinafter, for convenience of explanation, the touch sensor structure of FIG. 2 will be used as an example in describing a touch display device 100 according to one or more embodiments of the present disclosure.

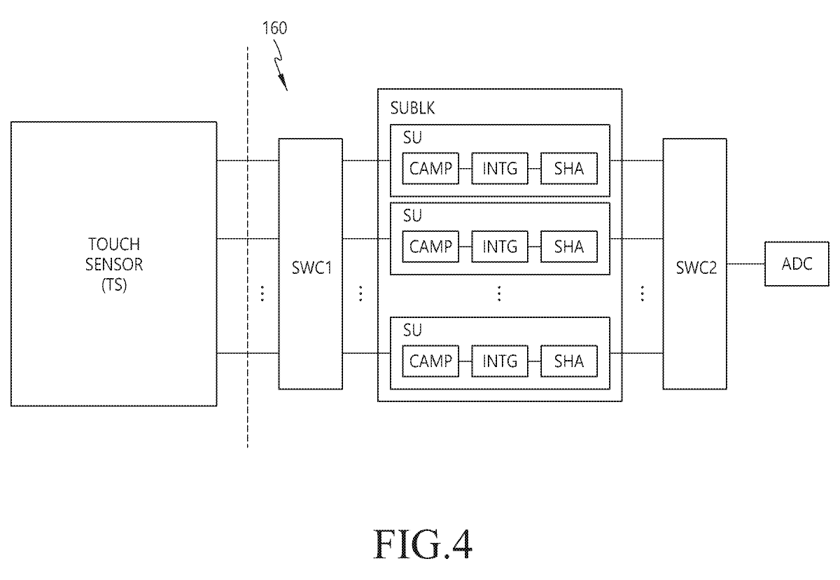

FIG. 4 illustrates an implementation example of a touch driving circuit 160 according to one or more embodiments of the present disclosure.

Referring to FIG. 4, the touch driving circuit 160 according to one or more embodiments of the present disclosure may include a sensing unit block SUBLK for detecting a touch sensing signal from a touch sensor TS. The sensing unit block SUBLK may include a plurality of sensing units SU.

According to one or more embodiments, the touch driving circuit 160 according to one or more embodiments of the present disclosure may further include a first selection circuit SWC1, a second selection circuit SWC2, and an analog-to-digital converter ADC.

The first selection circuit SWC1 may connect the touch electrodes TE to be sensed among the plurality of touch electrodes TE included in the touch sensor TS to the sensing unit block SUBLK. The first selection circuit SWC1 may include a plurality of switches and may also be referred to as a multiplexer circuit.

Here, the multiplexer circuit may include at least one of a multiplexer having at least two input terminals and one output terminal, and a demultiplexer having one input terminal and at least two output terminals.

The second selection circuit SWC2 may connect one of the plurality of sensing units SU included in the sensing unit block SUBLK to an analog-to-digital converter ADC. The second selection circuit SWC2 may include a plurality of switches and may also be referred to as a multiplexer circuit.

According to the example of FIG. 4, each of the plurality of sensing units SU may include a charge amplifier CAMP, an integrator INTG, and a sample-and-hold circuit SHA.

The charge amplifier CAMP may be electrically connected to one or more touch electrodes TE selected by a first selection circuit SWC1 from among the plurality of touch electrodes TE included in the touch sensor TS.

The first selection circuit SWC1 may connect a touch electrode TE to be sensed among the plurality of touch electrodes TE to the charge amplifier CAMP within a corresponding sensing unit SU among the plurality of sensing units SU.

Accordingly, the charge amplifier CAMP within the corresponding sensing unit SU may receive a touch sensing signal from a touch electrode TE selected as a sensing target among the plurality of touch electrodes TE and connected thereto. That is, the charge amplifier CAMP within the sensing unit SU may detect a touch sensing signal from the touch electrode TE, which is the detection target. Here, the touch sensing signal detected by the touch electrode TE may correspond to a capacitance (e.g., mutual capacitance or self-capacitance) associated with the touch electrode TE.

The charge amplifier CAMP may output an output signal VOUT corresponding to the touch sensing signal detected by the touch electrode TE.

The integrator INTG may output an integral value obtained by integrating the output signal VOUT of the charge amplifier CAMP. Here, the charge amplifier CAMP and the integrator INTG may be implemented in an integrated manner.

The sample-and-hold circuit SHA may store the integral value output from the integrator INTG until the next integral value is output from the integrator INTG.

An analog-to-digital converter ADC may convert an integral value stored in a sample-and-hold circuit SHA within a sensing unit SU selected by a second selection circuit SWC2 into a digital value to generate touch sensing data.

The touch driving circuit 160 may transmit the touch sensing data generated by the analog-to-digital converter ADC to a touch controller 170. In this case, the touch sensing data may be transmitted in the form of a differential signal.

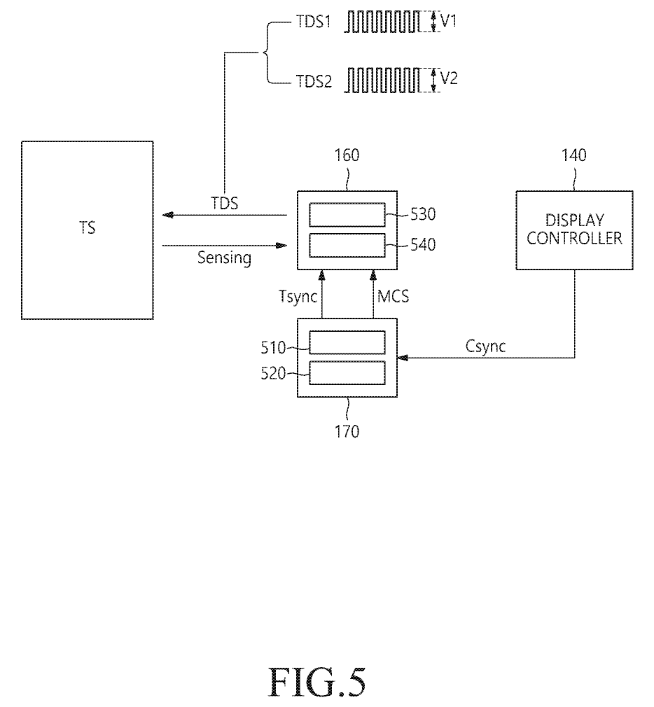

FIG. 5 illustrates a touch detection circuit 150 according to one or more embodiments of the present disclosure.

Referring to FIG. 5, a touch detection circuit 150 according to one or more embodiments of the present disclosure may include a touch driving circuit 160 to drive a touch sensor TS including a plurality of touch electrodes TE.

In addition, the touch detection circuit 150 may include a touch controller 170 that determines the coordinates of a user's touch operation (i.e., a contact touch, and a hover action during a non-contact touch) or a user's gesture (i.e., a gesture action during a non-contact touch) using touch sensing data obtained from the driving result (i.e., detection result) of the touch driving circuit 160.

The touch detection circuit 150 according to one or more embodiments of the present disclosure may operate in at least one of a contact touch mode and a non-contact touch mode during at least one touch period within a plurality of frames, each of which includes at least one touch period and a display period.

Hereinafter, a single frame including a plurality of touch periods (e.g., a first touch period and a second touch period) among the plurality of frames may be referred to as a dual touch detection frame, and a single frame including one touch period may be referred to as a single touch detection frame.

A contact touch mode may be a mode for detecting a user's contact touch, and a non-contact touch mode may be a mode for detecting at least one non-contact touch operation of the user's hover action and the user’s gesture action. Here, the non-contact touch mode may include a first non-contact touch mode for detecting a hover action and a second non-contact touch mode for detecting a gesture action.

For example, the contact touch mode may be a mode capable of detecting a contact touch, the first non-contact touch mode may be a mode capable of detecting a contact touch and a hover action, and the second non-contact touch mode may be a mode capable of detecting a contact touch, a hover action, and a gesture action.

For example, the contact touch mode, the first non-contact touch mode, and the second non-contact touch mode may be modes for supplying a touch driving signal TDS based on unit sensor node areas of different sizes.

Here, the 'unit sensor node area' may mean an area where the first touch electrode TE1 driven by the touch driving circuit 160 and the second touch electrode TE2 used for touch detection at the same timing in response to the driving of the first touch electrode TE1 intersect, and the size of the unit sensor node area may be expressed as 'a x b' based on the number of the first touch electrodes TE1 ‘a’ (where a is an integer greater than or equal to 1) and the number of the second touch electrodes TE2 ‘b’ (where b is an integer greater than or equal to 1) used for touch driving and detection at the same timing.

For example, at least two modes among the contact touch mode, the first non-contact touch mode, and the second non-contact touch mode may be modes in which touch driving signals TDS having different voltage levels are supplied to the touch sensor TS.

According to the example of FIG. 5, the touch driving circuit 160 may supply a first touch driving signal TDS1 having a first voltage level V1 to the touch sensor TS in a contact touch mode, and supply a second touch driving signal TDS2 having a second voltage level V2 higher than the first voltage level V1 to the touch sensor TS in a first non-contact touch mode and a second non-contact touch mode. For example, the first voltage level V1 and the second voltage level V2 may mean the amplitudes of the first touch driving signal TDS1 and the second touch driving signal TDS2.

However, the embodiments of the present disclosure are not limited thereto, and the touch driving circuit 160 may supply a touch driving signal having a third voltage level higher than the first voltage level V1 to the touch sensor TS in the first non-contact touch mode, and may supply a touch driving signal having a fourth voltage level higher than the third voltage level to the touch sensor TS in the second non-contact touch mode.

According to the example of FIG. 5, the touch controller 170 may include a synchronization signal generation unit 510 that supplies a touch synchronization signal Tsync and a mode control signal generation unit 520 that supplies a mode control signal corresponding to the touch synchronization signal Tsync.

For example, the synchronization signal generation unit 510 may generate a touch synchronization signal Tsync corresponding to at least one frame among a plurality of frames based on a control synchronization signal Csync supplied from the display controller 140.

For example, the control synchronization signal Csync may be a signal defining a touch period and a display period corresponding to each of a plurality of frames.

The touch controller 170 according to one or more embodiments of the present disclosure may control the touch driving circuit 160 to perform a non-contact touch mode during the first touch period and the second touch period within a first frame, which is a dual touch detection frame among the plurality of frames.

Specifically, the synchronization signal generation unit 510 may generate a touch synchronization signal Tsync defining the first touch period and the second touch period in the first frame based on the control synchronization signal Csync, and supply the generated touch synchronization signal Tsync to the touch driving circuit 160.

In addition, the mode control signal generation unit 520 may generate a mode control signal MCS for controlling operation in a non-contact touch mode during the first touch period and the second touch frame period within the first frame, and supply the mode control signal MCS to the touch driving circuit 160.

According to the example of FIG. 5, the touch driving circuit 160 may include a driving signal generation unit 530 for generating at least one touch driving signal TDS among the first touch driving signal TDS1 and the second touch driving signal TDS2 in response to the mode control signal MCS supplied from the touch controller 170, and a driving signal output unit 540 for supplying at least one touch driving signal TDS in at least one touch period within a single frame corresponding to the touch synchronization signal Tsync based on the touch synchronization signal Tsync supplied from the touch controller 170.

For example, the driving signal generation unit 530 may generate at least one touch driving signal TDS based on a reference touch driving signal supplied from the touch controller 170. The reference touch driving signal may be a signal with a variable voltage level. The reference touch driving signal may be a signal having a reference amplitude (i.e., a reference voltage level). For example, the reference touch driving signal may be a square wave, a sine wave, a triangular wave, etc. For example, the reference touch driving signal may be a pulse width modulation (PWM) signal.

Specifically, the driving signal generation unit 530 may generate a second touch driving signal TDS2 based on a mode control signal MCS that controls operation in a non-contact touch mode during a first touch period and a second touch frame period within a first frame.

In addition, the driving signal output unit 540 may supply the second touch driving signal TDS2 to the touch sensor TS during the first touch period and the second touch period within the first frame based on the touch synchronization signal Tsync corresponding to the first frame.

The touch driving circuit 160 may receive a touch sensing signal corresponding to the second touch driving signal TDS2 supplied to the touch sensor TS during the first frame from the touch sensor TS, and generate touch sensing data corresponding to the touch sensing signal and supply the generated touch sensing data to the touch controller 170.

The touch controller 170 may determine whether at least one touch operation among a contact touch and a non-contact touch has occurred in the first frame based on the touch sensing data corresponding to the first frame.

According to one or more embodiments of the present disclosure, if it is determined that a contact touch has been detected during at least one of the first touch period and the second touch period within a first frame, the touch controller 170 may control the touch driving circuit 160 to operate in a contact touch mode in a second frame subsequent to the first frame.

For example, the second frame may be a dual touch detection frame or a single touch detection frame.

That is, if a contact touch is detected during the first frame, which is a dual touch detection frame, the touch controller 170 may control the dual contact touch mode, which operates in the contact touch mode during the first touch period and the second touch period within the second frame, which is a dual touch detection frame.

Alternatively, if a contact touch is detected during the first frame, the touch controller 170 may control the single contact touch mode, which operates in the contact touch mode during a single touch period within the second frame, which is a single touch detection frame.

Here, the dual contact touch mode may be applied when latency reduction and smooth drawing performance are required, and the single contact touch mode may be applied in environments with a low signal-to-noise ratio (SNR).

The touch display device 100 according to one or more embodiments of the present disclosure may determine in advance the touch mode (i.e., dual contact touch mode or single contact touch mode) to be applied when a contact touch occurs by comprehensively considering touch latency time, drawing performance, and SNR.

According to the example of FIG. 5, if a contact touch is detected during a first frame, the synchronization signal generation unit 510 may supply one touch synchronization signal Tsync to the touch driving circuit 160 among a first touch synchronization signal defining a first touch period and a second touch period in a second frame following the first frame, and a second touch synchronization signal defining a single touch period in the second frame.

In addition, the mode control signal generation unit 520 may supply a mode control signal MCS to the touch driving circuit 160 for controlling operation in the contact touch mode during the first and second touch periods within the second frame, which is a dual touch detection frame, or during a single touch period within the second frame, which is a single touch detection frame.

The driving signal generation unit 530 may generate a first touch driving signal TDS1 based on the mode control signal MCS for controlling operation in the contact touch mode during the touch period within the second frame, which is a dual touch frame or a single touch frame.

In addition, the driving signal output unit 540 may supply the first touch driving signal TDS1 to the touch sensor TS during the touch period within the second frame, which is a dual touch frame or a single touch frame.

For example, if the second frame is a dual touch detection frame, the driving signal output unit 540 may supply the first touch driving signal TDS1 during the first touch period and the second touch period within the second frame.

Furthermore, if the second frame is a single touch detection frame, the driving signal output unit 540 may supply the first touch driving signal TDS1 during the single touch period within the second frame.

Meanwhile, if neither a contact touch nor a non-contact touch is detected during at least two consecutive frames among a plurality of frames, the touch controller 170 may control the touch driving circuit 160 to operate in a touch sleep mode in the p-th frame (where p is an integer greater than or equal to 1) following the at least two consecutive frames.

For example, the touch sleep mode may be a mode in which the touch detection circuit 150 does not perform a touch detection operation during the first touch period within the p-th frame, which is a dual touch detection frame, and the touch detection circuit operates in a non-contact touch mode during the second touch period within the p-th frame.

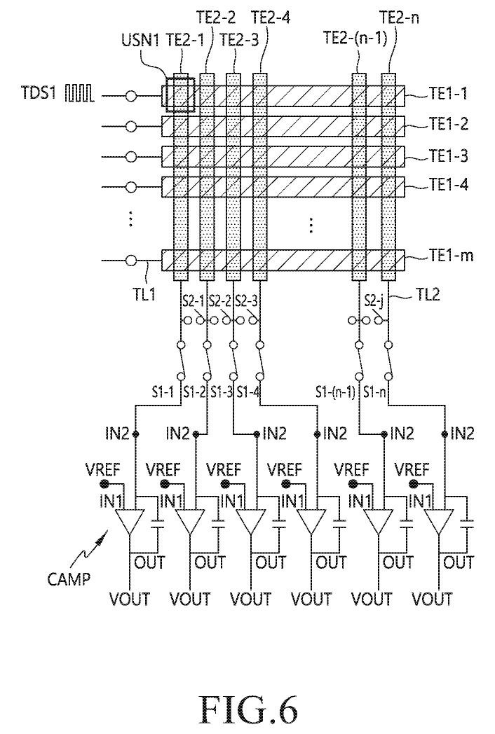

FIGS. 6 to 8 are diagrams for further explaining the contact touch mode and the non-contact touch mode according to one or more embodiments of the present disclosure.

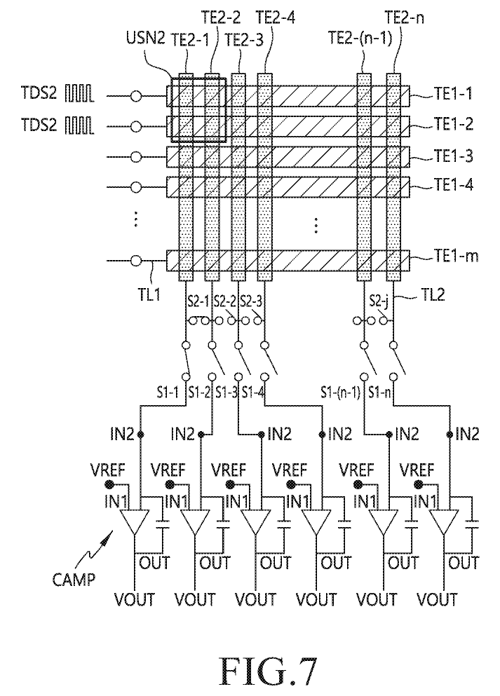

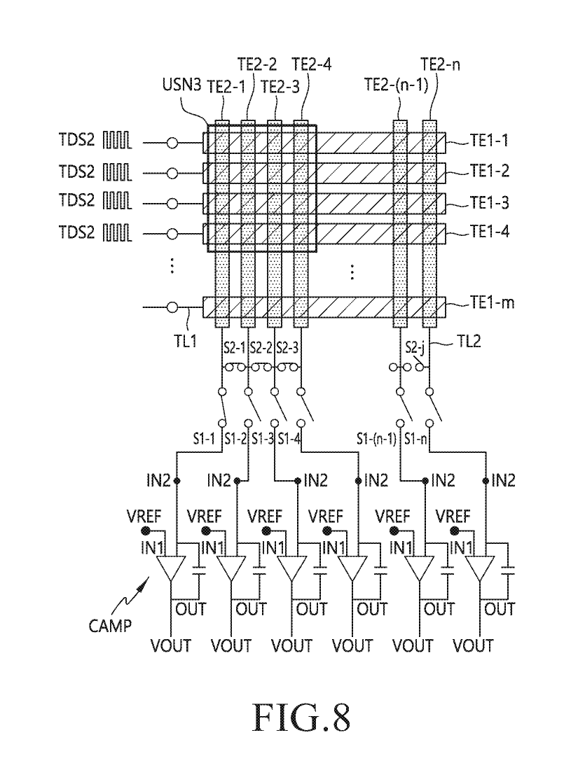

Specifically, FIG. 6 illustrates an operating state according to an example of a touch display device 100 in a contact touch mode, FIG. 7 illustrates an operating state according to an example of a touch display device 100 in a first non-contact touch mode, and FIG. 8 illustrates an operating state according to an example of a touch display device 100 in a second non-contact touch mode.

Referring to FIGS. 6 to 8, each of the plurality of first touch electrodes TE1-1 to TE1-m (where m is an integer greater than or equal to 1) may be connected to the touch driving circuit 160 through a plurality of first touch lines TL1, so that at least one of the first touch driving signal TDS1 and the second touch driving signal TDS2 may be supplied from the touch driving circuit 160.

Each of the plurality of second touch electrodes TE2-1 to TE2-n (where n is an integer greater than or equal to 1) may be electrically connected to at least one of the plurality of charge amplifiers CAMP arranged in the touch driving circuit 160 corresponding to each of the plurality of second touch electrodes TE2-1 to TE2-n through a plurality of second touch lines TL2, so that a touch sensing signal corresponding to at least one touch driving signal TDS may be output to the touch driving circuit 160.

According to the examples of FIGS. 6 to 8, the touch display device 100 according to one or more embodiments of the present disclosure may include a plurality of first switches S1-1 to S1-n that control electrical connections between a plurality of second touch electrodes TE2-1 to TE2-n and a plurality of charge amplifiers CAMP, and a plurality of second switches S2-1 to S2-j (where j is an integer greater than or equal to 1) that control electrical connections between two adjacent second touch electrodes among the plurality of second touch electrodes TE2-1 to TE2-n.

According to the examples of FIGS. 6 to 8, the charge amplifier CAMP may include a first input node IN1 to which a reference voltage VREF is input as an input voltage VIN having a constant voltage level, a second input node IN2 connected to the corresponding second touch line TL2 through a corresponding first switch among the plurality of first switches S1-1 to S1-n, and an output node OUT to which an output voltage (e.g., sensing voltage in analog form) VOUT is output.

That is, in the touch display device 100 according to one or more embodiments of the present disclosure, at least one second touch electrode among the plurality of second touch electrodes TE2-1 to TE2-n may be connected to one charge amplifier CAMP according to the switching operations of the plurality of first switches S1-1 to S1-n and the plurality of second switches S2-1 to S2-j.

However, the embodiments of the present disclosure are not limited thereto, and the touch display device 100 may not include at least one switch among the plurality of first switches S1-1 to S1-n and the plurality of second switches S2-1 to S2-j.

Referring to FIG. 6, in the contact touch mode, the touch driving circuit 160 may sequentially supply the first touch driving signal TDS1 to the plurality of first touch electrodes TE1-1 to TE1-m.

For example, the touch driving circuit 160 may sequentially supply the first touch driving signal TDS1 to each of a first-1 touch electrode TE1-1, a first-2 touch electrode TE1-2, ..., and a first-m touch electrode TE1-m.

According to the example of FIG. 6, the size of a first unit sensor node area USN1 in the contact touch mode may be '1×1'. In this case, assuming that the number of the plurality of first touch electrodes is 20 and the number of second touch electrodes is 54, the touch detection circuit 150 may perform a touch detection operation 1,080 times (i.e., 20×54) per first unit sensor node area USN1 during at least one touch period.

That is, in the contact touch mode, each of the plurality of first touch electrodes TE1-1 to TE1-m may be individually driven by a corresponding charge amplifier CAMP, and the plurality of second touch electrodes TE2-1 to TE2-n may be individually connected by a corresponding charge amplifier CAMP, so that a touch operation can be detected.

That is, in the contact touch mode, the plurality of first switches S1-1 to S1-n can be turned on, and the plurality of second switches S2-1 to S2-j can be turned off.

Referring to FIG. 7, in the first non-contact touch mode, the touch driving circuit 160 may sequentially supply the second touch driving signal TDS2 to the plurality of first touch electrodes TE1-1 to TE1-m, and may simultaneously supply the second touch driving signal TDS2 in units of k lines (where k is an integer greater than or equal to 2).

For example, in the first non-contact touch mode, the touch driving circuit 160 may supply the second touch driving signal TDS2 in units of two lines (i.e., k = 2).

For example, in the first non-contact touch mode, the touch driving circuit 160 may sequentially supply the second touch driving signal TDS2 to the first-1 and first-2 touch electrodes TE1-1 and TE1-2, the first-3 and first-4 touch electrodes TE1-3 and TE1-4, ..., the first-(m-1) and the first-m touch electrodes TE1-(m-1) and TE1-m.

According to the example of FIG. 7, the size of a second unit sensor node area USN2 in the first non-contact touch mode may be '2×2'. In this case, assuming that the number of the plurality of first touch electrodes is 20 and the number of second touch electrodes is 54, the touch detection circuit 150 may perform 270 (i.e., 10×27) touch detection operations per second unit sensor node area USN2 during at least one touch period.

According to the example of FIG. 7, while the second touch driving signal TDS2 is supplied to the first-1 and first-2 touch electrodes TE1-1 and TE1-2 in the first non-contact touch mode, the first-1 switch S1-1 and the second-1 switch S2-1 may be turned on, and the first-2 to first-n switches S1-2 to S1-n and the second-2 to second-j switches S2-2 to S2-j may be turned off, so that the second-1 and second-2 touch electrodes TE2-1 and TE2-2 may be connected to one charge amplifier CAMP to detect a touch operation.

Referring to FIG. 8, in the second non-contact touch mode, the touch driving circuit 160 may sequentially supply the second touch driving signal TDS2 to the plurality of first touch electrodes TE1-1 to TE1-m, and may simultaneously supply the second touch driving signal TDS2 in units of l lines (where l is an integer greater than k).

For example, in the second non-contact touch mode, the touch driving circuit 160 may supply the second touch driving signal TDS2 in units of four lines (i.e., l = 4).

For example, in the second non-contact touch mode, the touch driving circuit 160 may supply the second touch driving signal TDS2 to the first-1 to first-fourth touch electrodes TE1-1 to TE1-4, the first-5 to the first-8 touch electrodes TE1-5 to TE1-8, … , and the first-(m-3) to the first-m touch electrodes TE1-(m-3) to TE1-m.

According to the example of FIG. 8, the size of a third unit sensor node area USN3 in the second non-contact touch mode may be '4×4'. In this case, assuming that the number of the plurality of first touch electrodes is 20 and the number of second touch electrodes is 54, the touch detection circuit 150 may perform 70 (i.e., 5×14) touch detection operations per third unit sensor node area USN3 during at least one touch period.

That is, in the second non-contact touch mode, the touch driving circuit 160 may receive a touch sensing signal from l second touch electrodes while supplying the second touch driving signal TDS2 to l (e.g., l = 4) first touch electrodes.

According to the example of FIG. 8, while the second touch driving signal TDS2 is supplied to the first-1 and first-4 touch electrodes TE1-1 and TE1-4 in the second non-contact touch mode, the first-1 switch S1-1 and the second-1 to second-3 switches S2-1 to S2-3 may be turned on, and the first-2 to first-n switches S1-2 to S1-n and the second-4 to second-j switches S2-4 to S2-j may be turned off, so that the second-1 and second-4 touch electrodes TE2-1 and TE2-4 are connected to a single charge amplifier CAMP to detect a touch operation.

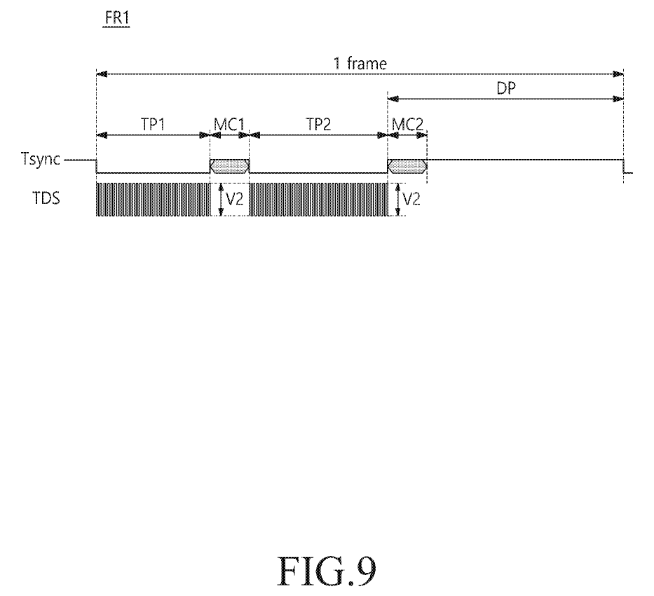

FIGS. 9 to 12 are diagrams for further explaining the operation process of the touch detection circuit 150 according to one or more embodiments of the present disclosure.

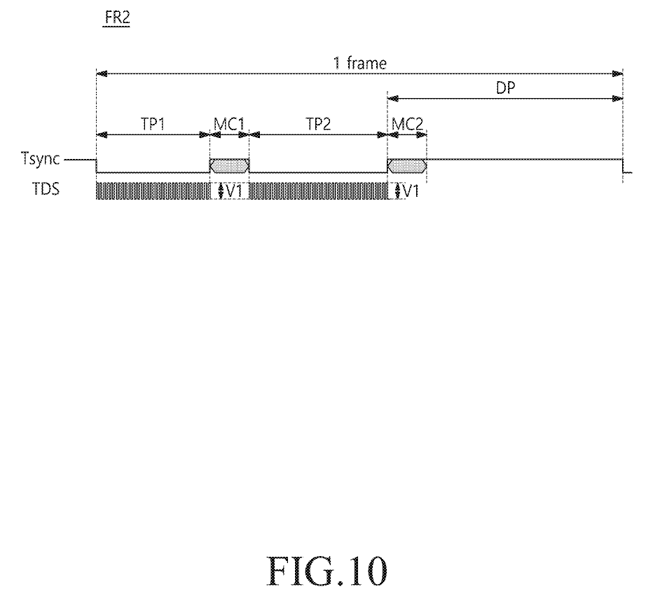

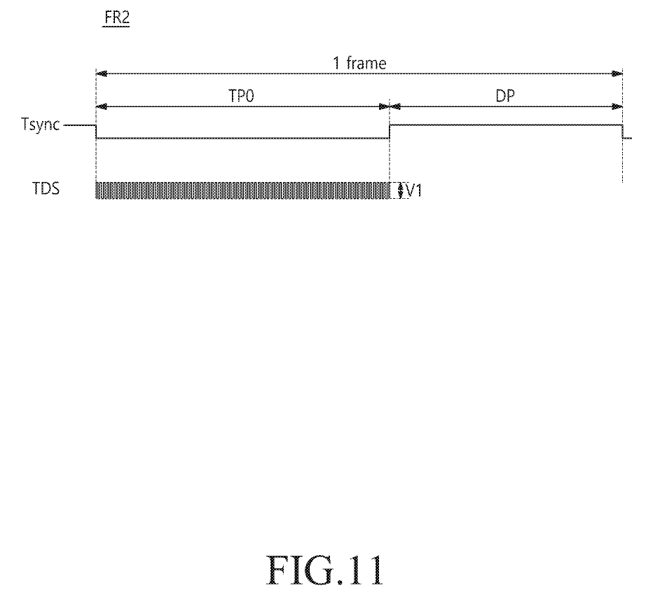

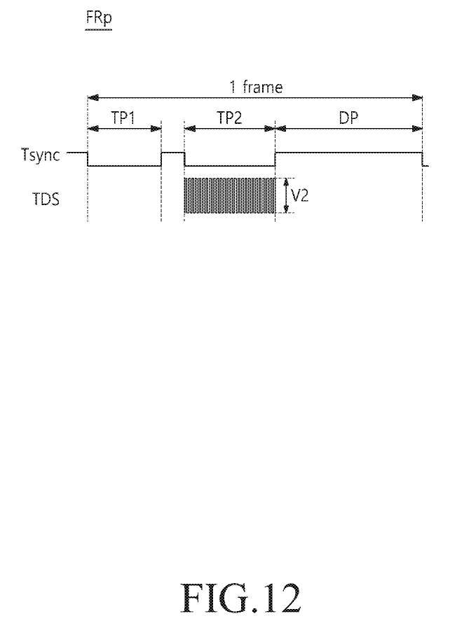

Specifically, FIG. 9 illustrates a timing diagram for the first frame FR1, which is a dual touch detection frame, FIG. 10 illustrates a timing diagram for the second frame FR2, which is a dual touch detection frame, FIG. 11 illustrates a timing diagram for the second frame FR2, which is a single touch detection frame, and FIG. 12 illustrates a timing diagram for the p-th frame, which is a dual touch detection frame operating in a touch sleep mode.

Each of the first frame FR1, the second frame FR2, a third frame, a fourth frame, and the p-th frame described below may represent a single frame (i.e., one frame).

Alternatively, each of the first frame FR1, the second frame FR2, the third frame, the fourth frame, and the p-th frame may represent a frame group including at least two consecutive single frames.

Referring to FIGS. 9 to 12, a touch display device 100 according to one or more embodiments of the present disclosure may operate based on at least one dual touch detection frame among a plurality of frames. The dual touch detection frame may include a first touch period TP1 and a second touch period TP2.

In addition, the dual touch detection frame may include a first mode transition period MC1 positioned between the first touch period TP1 and the second touch period TP2, and a second mode transition period MC2 subsequent to the second touch period TP2 and overlapping with a display period DP.

According to the examples of FIGS. 9 and 10, the first touch period TP1 and the second touch period TP2 may correspond to periods during which a touch synchronization signal Tsync of a low voltage level is applied within a single frame (i.e., one frame), and the first mode transition period MC1, the second mode transition period MC2, and the display period DP may correspond to periods during which a touch synchronization signal Tsync of a high voltage level is applied within a single frame.

However, the embodiments of the present disclosure are not limited thereto, and the first touch period TP1 and the second touch period TP2 may correspond to periods during which a touch synchronization signal Tsync of a high voltage level is applied within a single frame, and the first mode transition period MC1, the second mode transition period MC2, and the display period DP may correspond to periods during which a touch synchronization signal Tsync of a low voltage level is applied within a single frame.

According to one or more embodiments, the touch driving signal TDS may be synchronized with a falling edge and a rising edge of the touch synchronization signal Tsync corresponding to each touch period TP1 or TP2 to start and end the supply to the touch sensor TS.

However, the embodiments of the present disclosure are not limited thereto, and the touch driving signal TDS may be started and ended at a predetermined time after or before each of the falling edge and rising edge with respect to the falling edge and rising edge of the touch synchronization signal Tsync corresponding to each touch period TP1 or TP2.

According to the examples of FIGS. 9 and 10, the first mode transition period MC1 may be a period defined between the first touch period TP1 and the second touch period TP2.

However, the embodiments of the present disclosure are not limited thereto, and the first mode transition period MC1 may overlap with the first touch period TP1 or the second touch period TP2.

In other words, the touch synchronization signal Tsync may be maintained at the same voltage level (e.g., low level) from the start of the first touch period TP1 to the end of the second touch period TP2.

For example, if the first mode transition period MC1 overlaps with the first touch period TP1, the end time of the first mode transition period MC1 may be the same as the end time of the first touch period TP1, and if the first mode transition period MC1 overlaps with the second touch period TP2, the start time of the first mode transition period MC1 may be the same as the start time of the second touch period TP2, but the embodiments of the present disclosure are not limited thereto.

According to one or more embodiments, a touch driving signal TDS having different voltage levels may be applied in the first touch period TP1 defined before the first mode transition period MC1 and in the second touch period TP2 defined after the first mode transition period MC1.

That is, the first mode transition period MC1 may be a period during which the touch mode transitions from a contact touch mode to a non-contact touch mode, or a period during which the touch mode transitions from a non-contact touch mode to a contact touch mode.

The second mode transition period MC2 may overlap with the display period DP. For example, the start time of the second mode transition period MC2 may be the same as the start time of the display period DP. However, the embodiments of the present disclosure are not limited thereto, and the start time of the second mode transition period MC2 may be different from the start time of the display period DP.

Referring to FIG. 9, the touch detection circuit 150 may operate in a non-contact touch mode during the first frame FR1, which is a dual touch detection frame.

That is, the touch detection circuit 150 may supply a touch driving signal TDS (e.g., a second touch driving signal TDS2) having a second voltage level V2 to the touch sensor TS during the first touch period TP1 and the second touch period TP2 within the first frame FR1.

For example, the touch detection circuit 150 may operate in a first non-contact touch mode during the first touch period TP1 within the first frame FR1, and in a second non-contact touch mode during the second touch period TP2 within the first frame FR1.

In this case, the touch detection circuit 150 may switch the touch mode from the first non-contact touch mode to the second non-contact touch mode during the first mode transition period MC1 within the first frame FR1.

If a contact touch is detected during at least one of the first touch period TP1 and the second touch period TP2 within the first frame FR1, the touch detection circuit 150 may operate in a dual contact touch mode or a single contact touch mode in the second frame FR2 following the first frame FR1.

In this case, the touch detection circuit 150 may switch the touch mode from the second non-contact touch mode to the contact touch mode during the second mode transition period MC2 within the first frame FR1.

Referring to FIG. 10, if a contact touch is detected during the first frame FR1, the touch detection circuit 150 may operate in a dual contact touch mode during the second frame FR2.

In other words, the touch detection circuit 150 may operate in a contact touch mode during the first touch period TP1 and the second touch period TP2 within the second frame FR2.

That is, the touch detection circuit 150 may supply a touch driving signal TDS (e.g., a first touch driving signal TDS1) at a first voltage level V1 lower than the second voltage level V2 during the first touch period TP1 and the second touch period TP2 within the second frame FR2.

Specifically, the dual contact touch mode can increase the touch report rate when detecting a contact touch, thereby reducing delay time, supporting smoother drawing, and improving touch performance.

According to the example of FIG. 10, the touch detection circuit 150 may maintain the contact touch mode without changing the touch mode during the first mode transition period MC1 within the second frame FR2.

If a contact touch is detected during at least one of the first touch period TP1 and the second touch period TP2 within the second frame FR2, the touch detection circuit 150 may operate in the same dual contact touch mode as in the second frame FR2 in the third frame following the second frame FR2.

In this case, the touch detection circuit 150 may maintain the contact touch mode without changing the touch mode during the second mode transition period MC2 within the second frame FR2.

If no contact touch is detected during at least one of the first touch period TP1 and the second touch period TP2 within the second frame FR2, the touch detection circuit 150 may operate in the same non-contact touch mode as in the first frame FR1 in the third frame, which is a dual touch detection frame following the second frame FR2.

In this case, the touch detection circuit 150 may switch the touch mode from the contact touch mode to the first non-contact touch mode during the second mode transition period MC2 within the second frame FR2.

Referring to FIG. 11, if a contact touch is detected during the first frame FR1, the touch detection circuit 150 may operate in the single contact touch mode during the second frame FR2, which is a single touch detection frame.

That is, the touch detection circuit 150 may operate in a contact touch mode during a single touch period TP0 within the second frame FR2.

That is, the touch detection circuit 150 can supply a touch driving signal TDS, i.e., a first touch driving signal TDS1, at a first voltage level V1 during the single touch period TP0 within the second frame FR2.

Specifically, the single contact touch mode can increase the signal-to-noise ratio (SNR) by increasing the touch detection time during contact touch detection and improving touch accuracy and performance.

According to one or more embodiments, the second frame FR2 may include a single mode transition period that follows the single touch period TP0 and overlaps with the display period DP.

If a contact touch is detected during a single touch period TP0 within the second frame FR2, the touch detection circuit 150 may operate in the same single contact touch mode as in the second frame FR2 in the third frame following the second frame FR2.

In this case, the touch detection circuit 150 may maintain the contact touch mode without changing the touch mode during the single mode transition period within the second frame FR2.

According to one or more embodiments, if a contact touch is detected during the single touch period TP0 within the second frame FR2, but the detection signal according to the contact touch is below a preset threshold signal value, or noise is above a threshold noise value, the touch detection circuit 150 may operate in the dual contact touch mode in a frame following the second frame FR2.

If no contact touch is detected during the single touch period TP0 within the second frame FR2, the touch detection circuit 150 may operate in the same non-contact touch mode as in the first frame FR1 in the third frame, which is a single touch detection frame following the second frame FR2.

In this case, the touch detection circuit 150 may switch the touch mode from the contact touch mode to the first non-contact touch mode during the single mode transition period within the second frame FR2.

Referring to FIG. 12, if no contact touch or non-contact touch is detected during at least two consecutive frames among a plurality of frames, the touch detection circuit 150 may operate in the touch sleep mode during the p-th frame FRp following at least two frames.

For example, if no contact touch is detected during the second frame FR2, the touch detection circuit 150 may operate in a non-contact touch mode during the third frame following the second frame FR2. In addition, if neither a contact touch nor a non-contact touch is detected during the third frame, the touch detection circuit 150 may operate in a touch sleep mode during a fourth frame following the third frame.

The touch detection circuit 150 according to one or more embodiments of the present disclosure may also operate in the touch sleep mode during an initial operation of the touch display device 100.

The touch detection circuit 150 may not perform a touch detection operation during the first touch period TP1 within the p-th frame FRp, which is a dual touch detection frame operating in the touch sleep mode, and may operate in a non-contact touch mode during the second touch period TP2 within the p-th frame FRp.

For example, the touch detection circuit 150 may operate in a second non-contact touch mode during a second touch period TP2 within the p-th frame FRp.

In other words, the touch detection circuit 150 may not supply a touch driving signal TDS during the first touch period TP1 within the p-th frame FRp, but may supply a touch driving signal TDS, i.e., a second touch driving signal TDS2, having a second voltage level V2 during the second touch period TP2 within the p-th frame FRp.

According to one or more embodiments, if a gesture action among a non-contact touch operation of a user is detected during the p-th frame FRp while operating in touch sleep mode, the touch detection circuit 150 and the touch sensor TS may operate in a non-contact touch mode during a (p+1)-th frame, which is a dual touch detection frame following the p-th frame FRp.

Here, the touch detection circuit 150 and the touch sensor TS may operate in a first non-contact touch mode during a first touch period within the (p+1)-th frame, and may operate in a second non-contact touch mode during a second touch period within the (p+1)-th frame.

That is, the touch display device 100 according to one or more embodiments of the present disclosure may operate in the touch sleep mode in which a gesture action, which is a non-contact touch operation that can first detect a user's input, is detected, and a contact touch operation and a hover action as another non-contact touch operation are not detected, thereby minimizing or at least reducing the touch detection time, reducing current consumption, and operating at low power.

Embodiments of the present disclosure described above are briefly described as follows.

A touch display device according to one or more embodiments of the present disclosure may include a display panel on which a plurality of sub-pixels are arranged, a display driving circuit for driving the plurality of sub-pixels, and a touch detection circuit for detecting at least one touch operation of a contact touch and a non-contact touch through a touch sensor arranged on the display panel. The touch detection circuit may operate in a non-contact touch mode during a first touch period and a second touch

period within a first frame among a plurality of frames each including at least one touch period and a display period, and, if the contact touch is detected during at least one touch period among the first touch period within the first frame and the second touch period within the first frame, operate in a contact touch mode during a touch period within a second frame subsequent to the first frame.

If the contact touch is detected during the first frame, the touch detection circuit may operate in the contact touch mode during the first touch period within the second frame and the second touch period within the second frame.

If the contact touch is detected during the first frame, the touch detection circuit may operate in the contact touch mode during a single touch period within the second frame.

The touch detection circuit may supply a first touch driving signal having a first voltage level to the touch sensor in the contact touch mode, and supply a second touch driving signal having a second voltage level higher than the first voltage level to the touch sensor in the non-contact touch mode.

The non-contact touch mode may include at least one of a first non-contact touch mode for detecting a hover action among the non-contact touch, and a second non-contact touch mode for detecting a gesture action among the non-contact touch.

The touch detection circuit may operate in the first non-contact touch mode during the first touch period within the first frame, and operate in the second non-contact touch mode during the second touch period within the first frame.

The touch detection circuit may sequentially supply a touch driving signal to each of a plurality of touch lines connected to the touch sensor in the contact touch mode. The touch detection circuit may sequentially supply the touch driving signal to each of the plurality of touch lines by simultaneously supplying the touch driving signal in units of k lines (where k is an integer greater than or equal to 2) in the first non-contact touch mode. In addition, the touch detection circuit may sequentially supply the touch driving signal to each of the plurality of touch lines by simultaneously supplying the touch driving signal in units of l lines (where l is an integer greater than k) in the second non-contact touch mode.

If the contact touch is detected during the second frame, the touch detection circuit may operate in the contact touch mode in a third frame following the second frame.

If the contact touch is not detected during the second frame, the touch detection circuit may operate in the non-contact touch mode during a first touch period and a second touch period in a third frame following the second frame.

If the contact touch and the non-contact touch are not detected during at least two consecutive frames among the plurality of frames, the touch detection circuit may operate in a touch sleep mode in a p-th frame (where p is an integer greater than or equal to 1) following the at least two consecutive frames.

The touch sleep mode may be a mode in which the touch detection circuit does not perform a touch detection operation during a first touch period within the p-frame, and the touch detection circuit operates in the non-contact touch mode during a second touch period within the p-th frame.

The touch sleep mode may be a mode in which the touch detection circuit operates in the second non-contact touch mode for detecting the gesture action among the non-contact touch during a second touch period within the p-th frame.

If the contact touch is not detected during the second frame, the touch detection circuit may operate in the non-contact touch mode during a third frame following the second frame. In addition, if the contact touch and the non-contact touch are not detected during the third frame, the touch detection circuit may operate in the touch sleep mode during a fourth frame following the third frame.

At least one frame of the plurality of frames may include the first touch period, the second touch period, and a first mode transition period located between the first touch period and the second touch period.

The at least one frame may include a second mode transition period subsequent to the second touch period, and a display period subsequent to the second touch period and overlapping with the second mode transition period.

The touch sensor may include a plurality of first touch electrodes arranged in a first direction on the display panel, and a plurality of second touch electrodes arranged in a second direction intersecting the first direction on the display panel.

The touch detection circuit may includes a touch controller that supplies a mode control signal and a touch synchronization signal corresponding to the mode control signal, and a touch driving circuit that supplies a touch driving signal corresponding to the mode control signal and the touch synchronization signal to the touch sensor.

If the contact touch is detected during the first frame, the touch controller may supply the touch synchronization signal defining a first touch period and a second touch period in the second frame, and the mode control signal controlling to operate in the contact touch mode during a first touch period within the second frame and a second touch period within the second frame.

If the contact touch is detected during the first frame, the touch controller may supply the touch synchronization signal defining a single touch period in the second frame, and the mode control signal controlling to operate in the contact touch mode during the single touch period within the second frame.

A touch detection circuit according to one or more embodiments of the present disclosure may include a touch controller that supplies a mode control signal for controlling a touch mode for detecting at least one touch operation among a contact touch and a non-contact touch, and a touch synchronization signal corresponding to the mode control signal, and a touch driving circuit that supplies a touch driving signal corresponding to the mode control signal and the touch synchronization signal to a touch sensor arranged on a display panel. The touch controller may supply the touch synchronization signal defining a first touch period and a second touch period in a first frame among a plurality of frames each including at least one touch period and a display period, and the mode control signal controlling to operate in a non-contact touch mode during the first touch period within the first frame and the second touch period within the first frame. If the contact touch is detected during the first frame, the touch controller may supply one touch synchronization signal among a first touch synchronization signal defining a first touch period and a second touch period in a second frame following the first frame and a second touch synchronization signal defining a single touch period in the second frame, and the mode control signal controlling to operate in a contact touch mode during at least one touch period within the one touch synchronization signal.

The above description and the accompanying drawings provide an example of the technical idea of the present disclosure for illustrative purposes only. Various modifications, additions and substitutions to the described embodiments will be readily apparent to those skilled in the art without departing from the spirit and scope of the present disclosure. In addition, the disclosed embodiments are intended to illustrate the scope of the technical idea of the present disclosure. Thus, the scope of the present disclosure is not limited to the embodiments shown.

What is claimed is:

1. A touch display device, comprising:
a display panel on which a plurality of sub-pixels are arranged;
a display driving circuit for driving the plurality of sub-pixels; and
a touch detection circuit configured to detect at least one touch operation of a contact touch and a non-contact touch through a touch sensor arranged on the display panel,
wherein the touch detection circuit is configured to operate in a non-contact touch mode during a first touch period and a second touch period within a first frame among a plurality of frames, each of the plurality of frames including at least one touch period and a display period, and
wherein, if the contact touch is detected during at least one touch period among the first touch period within the first frame and the second touch period within the first frame, the touch detection circuit is configured to operate in a contact touch mode during a touch period within a second frame among the plurality of frames, the second frame being subsequent to the first frame.

2. The touch display device of claim 1, wherein, if the contact touch is detected during the first frame, the touch detection circuit is configured to operate in the contact touch mode during the first touch period within the second frame and the second touch period within the second frame.

3. The touch display device of claim 1, wherein, if the contact touch is detected during the first frame, the touch detection circuit is configured to operate in the contact touch mode during a single touch period within the second frame.

4. The touch display device of claim 1, wherein the touch detection circuit is configured to supply a first touch driving signal having a first voltage level to the touch sensor in the contact touch mode, and wherein the touch detection circuit is configured to supply a second touch driving signal having a second voltage level higher than the first voltage level to the touch sensor in the non-contact touch mode.

5. The touch display device of claim 1, wherein the non-contact touch mode includes at least one of a first non-contact touch mode for detecting a hover action among the non-contact touch, and a second non-contact touch mode for detecting a gesture action among the non-contact touch.

6. The touch display device of claim 5, wherein the touch detection circuit is configured to operate in the first non-contact touch mode during the first touch period within the first frame, and wherein the touch detection circuit is configured to operate in the second non-contact touch mode during the second touch period within the first frame.

7. The touch display device of claim 5, wherein the touch detection circuit is configured to sequentially supply a touch driving signal to each of a plurality of touch lines connected to the touch sensor in the contact touch mode,
wherein the touch detection circuit is configured to sequentially supply the touch driving signal to each of the plurality of touch lines by simultaneously supplying the touch driving signal in units of k lines in the first non-contact touch mode, k being an integer greater than or equal to 2, and
wherein the touch detection circuit is configured to sequentially supply the touch driving signal to each of the plurality of touch lines by simultaneously supplying the touch driving signal in units of l lines in the second non-contact touch mode, l being an integer greater than k.

8. The touch display device of claim 5, wherein, if the contact touch and the non-contact touch are not detected during at least two consecutive frames among the plurality of frames, the touch detection circuit is configured to operate in a touch sleep mode in a p-th frame among the plurality of frames that is subsequent to the at least two consecutive frames, p being an integer greater than or equal to 1.

9. The touch display device of claim 8, wherein the touch sleep mode is a mode in which the touch detection circuit does not perform a touch detection operation during a first touch period within the p-th frame, and wherein the touch detection circuit is configured to operate in the non-contact touch mode during a second touch period within the p-th frame.

10. The touch display device of claim 1, wherein at least one frame of the plurality of frames includes the first touch period, the second touch period, and a first mode transition period between the first touch period and the second touch period.

11. The touch display device of claim 10, wherein the at least one frame further includes a second mode transition period subsequent to the second touch period, and a display period subsequent to the second touch period, the display period overlapping with the second mode transition period.

12. The touch display device of claim 1, wherein the touch sensor includes a plurality of first touch electrodes arranged in a first direction on the display panel, and a plurality of second touch electrodes arranged in a second direction intersecting the first direction on the display panel.

13. The touch display device of claim 1, wherein the touch detection circuit includes:
a touch controller configured to supply a mode control signal and a touch synchronization signal corresponding to the mode control signal; and
a touch driving circuit configured to supply a touch driving signal corresponding to the mode control signal and the touch synchronization signal to the touch sensor.

14. The touch display device of claim 13, wherein, if the contact touch is detected during the first frame, the touch controller is configured to supply the touch synchronization signal defining a first touch period and a second touch period in the second frame, and is configured to supply the mode control signal for controlling the touch detection circuit to operate in the contact touch mode during a first touch period within the second frame and a second touch period within the second frame.

15. The touch display device of claim 13, wherein, if the contact touch is detected during the first frame, the touch controller is configured to supply the touch synchronization signal defining a single touch period in the second frame, and is configured to supply the mode control signal for controlling the touch detection circuit to operate in the contact touch mode during the single touch period within the second frame.

16. A touch detection circuit, comprising:
a touch controller configured to supply a mode control signal for controlling a touch mode for detecting at least one touch operation among a contact touch and a non-contact touch, and a touch synchronization signal corresponding to the mode control signal; and
a touch driving circuit configured to supply a touch driving signal corresponding to the mode control signal and the touch synchronization signal to a touch sensor arranged on a display panel,
wherein the touch controller is configured to supply the touch synchronization signal defining a first touch period and a second touch period in a first frame among a plurality of frames, each of the plurality of frames including at least one touch period and a display period,
wherein the touch controller is configured to supply the mode control signal for controlling the touch detection circuit to operate in a non-contact touch mode during the first touch period within the first frame and the second touch period within the first frame,
wherein, if the contact touch is detected during the first frame, the touch controller configured to supply one touch synchronization signal among a first touch synchronization signal defining a first touch period and a second touch period in a second frame subsequent to the first frame, and a second touch synchronization signal defining a single touch period in the second frame, and is configured to supply the mode control signal for controlling the touch detection circuit to operate in a contact touch mode during at least one touch period within the one touch synchronization signal.

17. A touch display device, comprising:
a display panel;
a touch sensor on the display panel, the touch sensor including a plurality of touch electrodes; and
a touch driving circuit configured to detect a touch operation through the touch sensor, the plurality of touch electrodes electrically connected to the touch driving circuit via a plurality of touch lines, the touch driving circuit comprising:
a sensing unit block configured to detect a touch sensing signal from the touch sensor indicative of the touch operation, the sensing unit block including a plurality of sensing units,
a plurality of first switches connected to the plurality of touch lines, each of the plurality of first switches configured to control electrical connection between one of the plurality of touch electrodes and a corresponding one of the plurality of sensing units, and
a plurality of second switches, each switch of the plurality of second switches connected between corresponding two touch lines of the plurality of touch lines and configured to control electrical connection between corresponding two touch electrodes of the plurality of touch electrodes.

18. The touch display device of claim 17, wherein, in a contact touch mode of the touch display device, the plurality of first switches are configured to be turned on electrically connecting the plurality of touch electrodes with the plurality of sensing units, and
wherein, in the contact touch mode, the plurality of second switches are configured to be turned off disconnecting the plurality of touch electrodes from each other.

19. The touch display device of claim 17, wherein, in a first non-contact touch mode of the touch display device, a first switch of the plurality of first switches is configured to be turned on electrically connecting a first touch electrode of the plurality of touch electrodes with a first sensing unit of the plurality of sensing units,
wherein, in the first non-contact touch mode, other switches of the plurality of first switches different from the first switch are configured to be turned off disconnecting other touch electrodes of the plurality of touch electrodes different from the first touch electrode from the plurality of sensing units,
wherein, in the first non-contact touch mode, a second switch of the plurality of second switches is configured to be turned on electrically connecting a second touch electrode of the plurality of touch electrodes with the first touch electrode and the first sensing unit, and
wherein, in the first non-contact touch mode, other switches of the plurality of second switches different from the second switch are configured to be turned off disconnecting remaining touch electrodes of the plurality of touch electrodes from the first touch electrode and the second touch electrode.

20. The touch display device of claim 17, wherein, in a second non-contact touch mode of the touch display device, a first switch of the plurality of first switches is configured to be turned on electrically connecting a first touch electrode of the plurality of touch electrodes to a first sensing unit of the plurality of sensing units,
wherein, in the second non-contact touch mode, other switches of the plurality of first switches different from the first switch are configured to be turned off disconnecting other touch electrodes of the plurality of touch electrodes different from the first touch electrode from the plurality of sensing units, and
wherein, in the second non-contact touch mode, a second switch of the plurality of second switches is configured to be turned on, a third switch of the plurality of second switches is configured to be turned on and a fourth switch of the plurality of second switches is configured to be turned on electrically connecting a second touch electrode of the plurality of touch electrodes, a third touch electrode of the plurality of touch electrodes and a fourth touch electrode of the plurality of touch electrodes with the first touch electrode and the first sensing unit.
